(19) United States
(12) Patent Application Publication
(10) Pub. No.: US 2012/0288674 A1
(43) Pub. Date: Nov. 15, 2012

(54) Surfaces Suitable for Directionally Reflective Roofs and Methods Thereof

(76) Inventor: Matthew Murray Botke, Moorpark, CA (US)

(21) Appl. No.: 13/472,064

(22) Filed: May 15, 2012

Related U.S. Application Data
(60) Provisional application No. 61/486,323, filed on May 15, 2011.

(51) Int. Cl. E04B 7/18; B32B 3/28; B05D 1/12

(52) U.S. Cl. 428/141; 52/745.06; 427/186; 428/174

(57) ABSTRACT

This invention relates to various methods of improving the energy efficiency and utility of roofs typically of the flexible membrane granulated type including shingles and roll roofing using a series of generally continuous curved surfaces although is applicable to all types of roofing including metal, concrete, and clay roofing products. Further, this invention relates to a spacer apparatus used to effect several methods of improving the utility and efficiency of roofing of this class.

### CROSS REFERENCE TO RELATED APPLICATIONS

I claim priority to U.S. Provisional Application No. 61/486,323 filed on May 15, 2011 entitled Undulating Roof Profile for Enhanced Energy Performance and Functionality

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Heat energy transfer through the building envelope changes the temperature of the interior space and can make the space uncomfortable. Energy must be expended to maintain the desired temperature if this space is conditioned in order to offset energy transfer to or from the environment. Therefore, minimal energy transfer across the envelope is desirable. The rate of energy transfer across the building envelope becomes significant when large temperature differences exist between the ambient environment and the interior space. A primary source of heat energy loading on the envelope is due to the absorption of direct solar radiation and a secondary source is the absorption of diffuse solar radiation into the exposed surfaces of the envelope. The outer surface of the envelope is typically comprised of a cladding system by which panels, coatings, tiles, shingles and the like are arranged over the building substrate in order to provide a contiguous weather resistant layer. Characteristics by which the outer surface interacts with incident solar radiation have significant affect on the heat transfer between the interior space and the outside environment. Traditionally, the energy required to cool a conditioned space is more expensive than the equivalent energy required for heating the same space due to the type of energy required for each application. Therefore, envelope performance is designed to minimize solar heat gain in the summer and secondarily to maximize solar heat gain in the winter for much of the globe between about 50-deg North and 50-deg South latitude.

Elevation and azimuth sun angles vary according to time of year, time of day, and the positional latitude on the Earth from which the angles are measured. Peak heating occurs in the hours surrounding solar noon when the elevation angle of the sun is at or near the daily maximum. Energy used to cool a conditioned space in the summer most often reaches a maximum in the early afternoon as a result of the energy absorbed into the active thermal mass of the envelope during the solar noon hours. For example, during summer solstice at 34-deg N latitude, the sun elevation angle remains above 40-deg for over seven hours. By comparison, during winter solstice the sun reaches a maximum of only approximately 35-deg elevation angle at solar noon. A building outer surface that is responsive to sun elevation angles enables substantial reductions in energy use especially during the cooling season

Energy transfer across the building envelope can be effectively mitigated by the outer building surface geometry as well as thermal and thermo-optical properties. Some relevant properties according to the present invention are;
a. reflectivity, which herein describes the non-wavelength dependent total fraction of incident solar radiation reflected and is measured on a scale of 0 to 1, whereas 1 is a perfect reflector,
b. absorptivity, which herein describes the non-wavelength dependent fraction of incident solar radiation absorbed and is measured on a scale of 0 to 1, whereas 1 is a perfect absorber and;
c. emissivity, which herein describes the non-wavelength dependent effectiveness of emitting or radiating absorbed energy to the surroundings for a given temperature difference between the cladding and surroundings assuming optically thick materials and is measured on a scale of 0 to 1, whereas 1 is a perfect blackbody emitter and;
d. thermal capacitance per unit mass which herein describes the temperature rise of the materials for a given unit of energy input and;
e. thermal conductivity, which herein describes the time rate of heat energy conducted through materials and into or out of surroundings in physical contact.

Since even highly reflective materials absorb some solar radiation, building materials can be advantageously designed to manage the absorbed heat energy. Absorbed heat energy raises the outer surface temperature in proportion to the thermal capacity and thermal mass of the material in thermal proximity. The absorbed energy is then typically transferred through conduction and radiation into the building substrate, re-radiated into the surroundings, and or transferred through convection to the air. Roofs comprised of a low emissivity surface exposed to the environment will reach a higher peak temperature compared to a similar roof with higher emissivity resulting in increased local air temperature through convective heat transference. The effects of local air heating in regions with a high proportion of absorbing surfaces such as in developed areas is known as the Heat Island Effect and can be a significant source of heat gain into buildings as well as result in decreased air quality.

Both high reflectivity and high emissivity improve the effectiveness of building cladding to reject solar gain just as high absorptivity and low emissivity increase solar gain. Metals traditionally used for building construction such as cladding include bright zinc galvanized steel (emissivity=0.23 to 0.28), aluminum (emissivity=0.02 to 0.19) and stainless steel (emissivity=0.08 to 0.20) and so are typically coated. While bare metals are excellent reflectors, these materials do not effectively emit heat energy compared to other building materials such as paint, masonry, rock, and roofing granules (emissivity>0.70). Building outer surface energy performance increases by the use of materials that are greater than about 0.2 reflective and greater than about 0.5 emissive for surfaces designed to reject solar gain. Some examples of suitable reflective and emissive coatings are light-colored paints, and polymer coatings such as UV stabilized PVDF (Polyvinylidene Fluoride), TPO (thermoplastic olefin), epoxy paints pigmented with Titanium Oxides or synthetic pigments of similar reflectivity. Adhesive coatings are also available that are suitable for building surfaces and have an acceptable reflectivity.

Most available high reflectivity building outer surface systems have been incorporated into commercial roof structures, which typically comprise a large area fraction exposed to the sun and have nearly flat roofs that are not commonly visible. These types of roofs are not limited by ornamental requirements and most often are white or lighter in color. Buildings with inclined roofs such as residential structures benefit from the same technologies that have been developed for commercial structures. Since darker colors are preferred for visible roofs, high reflectivity roofing has not been widely adopted in residential buildings.

Granulated roofing products are very economical and in very wide use. Typically, these types of roofing systems are sold as tabbed shingles or roll roofing products generally constructed of asphalt saturated mat and granules of various colors. Several disadvantages exist in the current state of the art regarding energy performance and versatility. Since this type of roofing makes intimate contact with the underlying roofing structure, much of the solar energy absorbed is easily conducted into the structure of the building. Also, a general lack of highly reflective options for sloped roof systems result in increased building energy use during the heating season.

### BRIEF SUMMARY OF THE INVENTION

Sloped roofs such as those typically found on residential buildings comprise a large fraction of the appearance of the building to users and also present a large exposed surface to the sun. Since the view factor of the roof presented to observers differs from the view factor to the sun essentially throughout the entire day, the roof can be configured to exhibit different properties for each such as reflectivity and apparent color. Sloped roof systems are viewed from below the elevation of the roof from a generally predictable locus of points, herein referred to as common viewing positions, determined by the typical interaction of people with each particular building. Normal routes of ingress, egress, commonly accessible areas such as driveways, parking lots, and lawn areas, as well as views from proximal transit routes such as streets and sidewalks comprise normal viewing locations from which the roof of the building contributes to the overall aesthetics of the architecture. Generally, architectural aesthetics are most relevant when the observer is in close proximity to the building. More specifically, common viewing positions herein relates primarily to observers standing at ground level within about 60-meters from a building roof. Of course, the observer view of the roof will vary according to observer location relative to the roof surface, building height, and roof pitch. The view factor of the roof to the sun can be determined based on location upon the earth, roof surface orientation, date, and time of day.

This invention relates to pitched roofing systems with a generally undulating shape along the pitch of the roof. More specifically, this invention relates to roofing materials whereby at least one generally convex shape is imparted to a roofing product such as a tabbed granulated asphalt shingle, roll roofing material, tile or metal roofing. This can be imparted either by substantially integral construction and or by means of a spacer under the roofing product to provide a conformal surface upon which the roofing product rests and or is bonded. Of course, any generally continuous shape is applicable to this invention and may even be a very sophisticated mathematical function or even more than one function with varying slope and multiple maxima and minima along the pitch of the roof. This shape may repeat along the pitch of the roof or vary. Several methods and apparatuses are disclosed herein in order to affect this shape especially in flexible membrane roofing and the several advantages associated with roofs according to this invention in general.

Shingle spacers have been known since at least U.S. Pat. No. 1,709,376 awarded to Shirley and have been used to increase the insulation, ventilation, and aesthetics of roofs as well as to reduce the number of shingles required per unit area. Shingle spacers offer many advantages including improved air ventilation, insulation, volume between the outer weathering layer and the roof deck for equipment mounting brackets, and many other uses. Another advantage of a shingle spacer according to this invention is the local change in orientation of a portion of the exposed surface of the roof material. The a roof according to this invention is generally undulating along the pitch and results in a portion of the roofing product comprising a greater portion of the visual scene by persons at common viewing positions. Another portion of the roofing product then comprises a greater portion of the visual scene to higher viewing angles resulting in a high view factor to the sun especially at high sun elevation angles typical of the summer season sun especially around the hours of solar noon. A roof according to this invention integrates materials with enhanced solar reflectivity on the portions of the roof with reduced visibility from common viewing positions such as by painting, coating, by the presence of desirably reflective roofing granules, and or by any combination of these methods in order to achieve improved energy efficiency with minimal decrease in ornamental quality. In addition, the imparted shape provides utility routing pathways for energy transport, storage, and utilization. A roof spacer is also disclosed according to this invention that has reduced visibility when observed from common viewing positions.

### BRIEF DESCRIPTION OF THE SEVERAL VIEWS OF THE DRAWINGS

FIG. 1 is a perspective view of a roof system according to this invention.

FIG. 2 is a roofing shingle according to this invention with undulating surface features in rows.

FIG. 3 is a cross section of a portion of the roofing shingle in FIG. 2.

FIG. 4 is a roofing shingle according to this invention with undulating surface features revolved as a bump.

FIG. 5 is a roofing tile according to this invention with undulating surface features following the profile of the tile according to this invention

FIG. 6 is a roofing shingle and shingle spacer together forming undulating surface features.

FIG. 7 is a roofing shingle with portions of the exposed area having characteristics to enhance energy efficiency and ornamental quality when formed into an undulating shape.

FIG. 8 is a cross section of a roof assembly on an inclined building surface illustrating one method of installation.

FIG. 9 is a shingle spacer having drainage and ventilation features for enhanced functionality.

FIG. 10 is a shingle spacer according to this invention having means of securing roof-mounted equipment.

FIG. 11 is a shingle spacer having a headlap and or utility routing pathways.

FIG. 12 is a shingle spacer having means of integrating decorative lights on the roof of a building.

### DETAILED DESCRIPTION OF THE INVENTION

Embodiments of this invention relate to the exposed outer profile of roofing systems generally for the purposes of energy performance while maintaining ornamental quality and weather resistant functionality. A generally undulating profile of successive corrugations in a roof along the pitch of the roof and extending along the outer surface of the roof generally in the horizontal direction results in portions of the roof of greater visibility by persons at common viewing positions and portions of lesser visibility. Those portions of lesser visibility by persons at common viewing positions are generally more upward facing and comprise a large part of the sun view factor at increasingly higher elevation angles.

FIG. 1 illustrates a simple embodiment of a roof according to this invention. The generally undulating shape is shown as a series of corrugated profiles along the pitch of the roof from the fascia (3) to the ridge (4). Each undulating profile has a portion of the exposed area having desirable reflectivity (1) for interaction at a high viewing angle such as toward a summer sun elevation angle (9) and a portion of the exposed area having desirable ornamental quality (2) for interaction at a low viewing angle such as comprising a significant area fraction of the visible scene by persons at common viewing positions (7). Therefore, a roof according to this invention becomes passively and progressively effectively more reflective as the angle of incident solar radiation increases. The portions (1) and (2) may transition gradually in appearance to reduce visible contrast therefore preferably not exceeding the contrast threshold of the human eye in common lighting conditions and from common viewing positions while maintaining acceptable solar reflectivity performance. This transition area also serves to reduce manufacturing and installation complexity by reducing building surface pitch sensitivity. Of course, this transition is dependent upon the predominant ornamental visual characteristics of the exposed ornamental portion (2) and the apparent visual characteristics of the reflective portion (1). The transitional surfaces are also dependent upon other visual methods that may be utilized including patterns of texture, shape, gloss, luminance, saturation as well as hue and the like to also facilitate decreased sensitivity of the human eye in perceiving ornamentally unacceptable delineation between ornamental and desirably reflective portions of the roof surface.

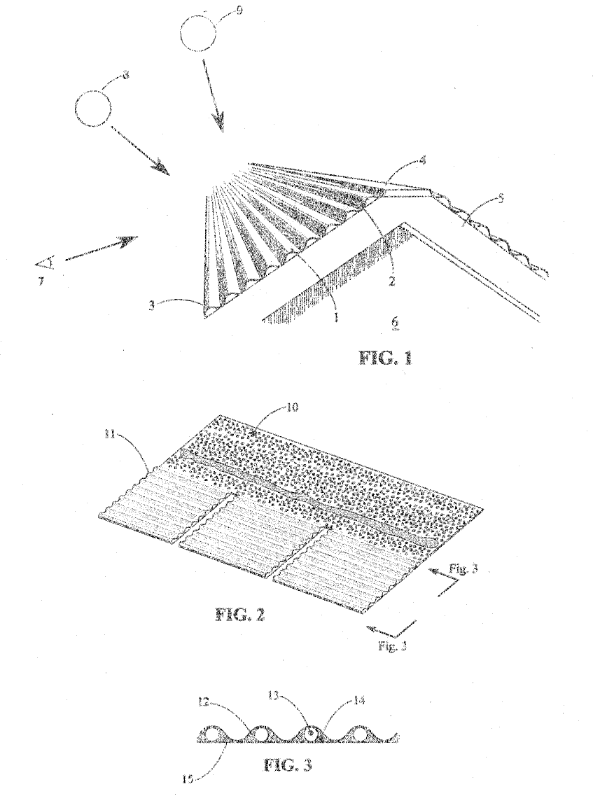

FIG. 2 illustrates a contemplated embodiment of this invention as a roofing shingle such as a granulated asphalt three-tab roofing shingle. Roll roofing and other roofing systems suitable for processing described herein are contemplated. The exposed tab areas (11) are shown with integral undulating surfaces. These surface profiles may be added during manufacture or as a secondary process to manufactured shingles such as by using a heated roller or press to impart the desired profile into the roofing material. These features may even be added in situ after the roofing product has been installed such as for energy performance retrofitting. The undulating features may extend over the entire surface of the roofing product or just on the exposed surfaces or any desired portion of the surface area. Undulating surfaces according to this invention added to the headlap (10) have a benefit of reducing thermal conductivity from the overlapping shingle of the subsequent course and is an aspect of this invention. Of course, the undulating surfaces may also be imparted on the underside of the roofing product to further decrease thermal conduction and or increase ventilation. FIG. 3 illustrates a cross section of the embodiment shown in FIG. 2 illustrating a weathering layer such as asphalt (14) with granules on the outer surface (12) and a bottom layer (15) of for example an asphalt impregnated mat. The undulating profile may be imparted to the roofing material by use of tooling such as a suitably profiled roller or platen. A filler material (13) such as a cord or a hollow tube may be used as a filler material to reduce the volume of the weathering layer (14) required according to the desired profile. By reducing the size of the profiled surfaces, filler materials such as (13) become unnecessary and the features may be imparted directly. An optimum profile wavelength for standard 30-year lifetime shingles has been found to be approximately 4-mm. Profiles of this size may be imparted directly into a slightly heated shingle by a press and achieve sufficiently detailed features. At scales of this size, the surface roughness becomes a significant fraction of the height of the profile thereby also advantageously reducing visual perception of the profiled surfaces. Similarly, as feature sizes are reduced, a higher color contrast can be used for improved energy performance while maintaining the same visual sensitivity according the typical contrast sensitivity curve of the human eye.

FIG. 4 illustrates a further contemplated embodiment of a roofing material according to the present invention whereby undulating features are revolved about an axis such as bumps (17) imparted to the roofing product (16) such as an asphalt shingle using a suitably profiled tool. Rain shedding of the roofing material is enhanced by discontinuous undulations that provide less resistance to flow. Feature density per unit area of exposed roofing surface area, reflectivity of surfaces on areas of reduced visibility from common viewing positions, and profile of the bumps affect energy performance.

FIG. 5 illustrates a roofing tile, commonly known as a Malibu or Spanish tile typically constructed of clay or concrete with undulating surface features (19) according to this invention. Feature size may range from approximately 0.1-mm to 10's of millimeters in height and can have a period between local maxima with a similar range as well. The undulating features may also follow the contours of profiled roofing products as illustrated for ease of fabrication without unacceptable degradation of performance and even follow a pseudo random pattern along the roof surface. Also, undulating profiles may be discontinuous as illustrated by the absence of undulating features along the gutter area (20). Further, undulating features may even be randomly distributed and not follow any repeating path and still retain acceptable performance. For extruded roofing products such as tile and the like, surface features according to this invention may be imparted by molding such as by a roller before the tile is fully cured, or by any other method of displacing or material from the tile such as by a mold or other suitable tooling. It is an aspect of this invention that surface features may vary from regularly-ordered undulating features continuous or not to a random distribution of discontinuous features such as bumps and even a textured surface either integral to the roofing material such that a large fraction of the resultant surface area is oriented either toward the view direction or toward the sun direction.

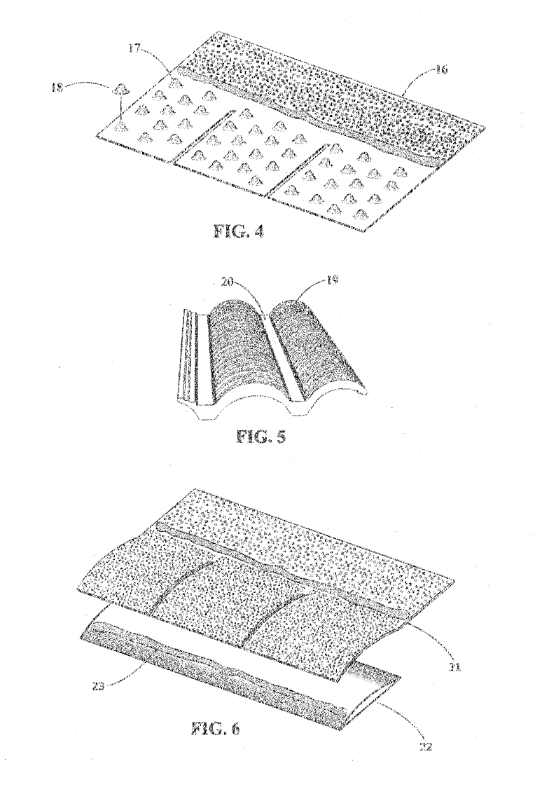

FIG. 6 illustrates another contemplated embodiment whereby a shingle spacer (22) is used with a flexible roofing product (21) such as a granulated asphalt shingle to form a profile according to this invention. It is an aspect of this invention that the shingle spacer is curved to enable the roofing product to conform to this shape and the spacer be substantially hidden from view. The spacer illustrated in FIG. 6 is shown with one generally convex shape but can have any number of maxima and minima and is generally limited by the flexibility and durability of the roofing product under which the spacer is placed. The resulting exposed surfaces of the assembly substantially hidden from view from persons at normal viewing positions are then treated to enhance reflectivity such as by coating with a suitably reflective and durable material. The shingle spacer is illustrated with an adhesive strip (23) of the kind commonly in use such as a temperature-activated petroleum adhesive and serves to bond the roofing product to resist high winds.

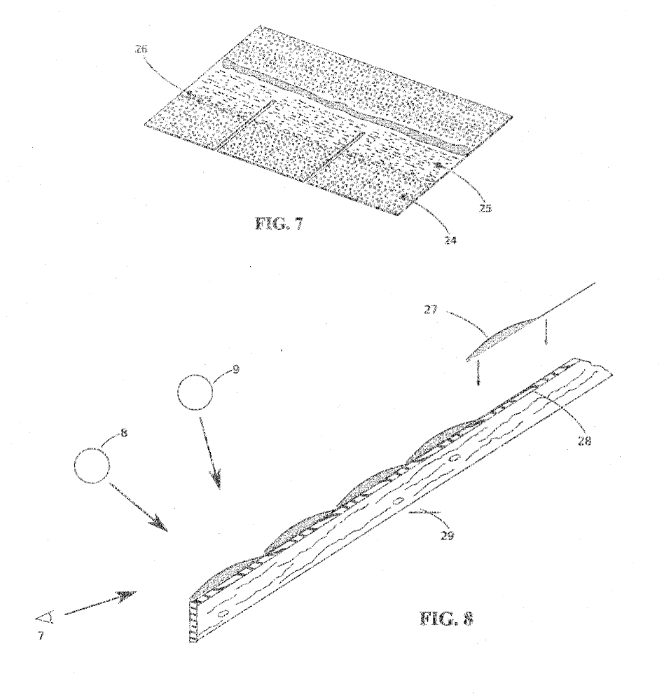

FIG. 7 illustrates a flexible roofing product such as a granulated asphalt shingle that might be used in combination with the shingle spacer (22) with a first portion of the exposed surface (24) having a first set of characteristics such as ornamental quality and traditional reflectivity and a second portion of the exposed surface (25) having a second set of characteristics such as desirable reflectivity. A third portion such as a blended portion of the exposed surface (26) serves to reduce visual sensitivity of the difference in visual appearance between the first and second portions. The shingle having been treated before assembled onto the shingle spacer.

FIG. 8 illustrates the assembly of a roof in cross section according to this invention whereby a flexible roofing product such as a shingle and a shingle spacer (27) are assembled over the underlying structure (28) at an incline to the horizontal (29) to create a weather resistant cladding system. A first portion of the exposed surface (24) is predominantly visible from a first viewing angle (7) such as a common viewing angle while a second exposed surface comprises a desirable fraction of the view factor from a second viewing angle (9) such as a high sun elevation angle. An intermediate viewing angle (8) is comprised of a combination of a first and second viewing angle.

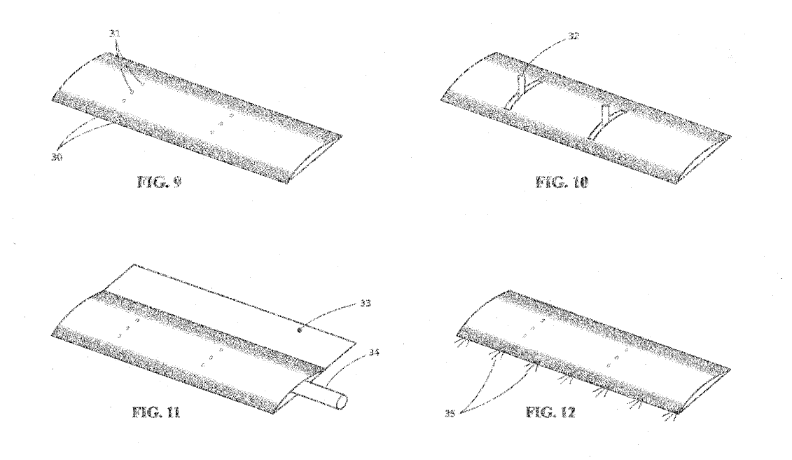

The shingle spacer provides not only a conformal profile to maintain the roofing product in the desired shape for directional reflectivity according to this invention, but also provides many other benefits that are an aspect of this invention. Contemplated embodiments are illustrated in FIGS. 9 through 12. One significant benefit is a reduction of thermal conductivity between the roofing product and the underlying roof structure by providing a gap between the outer exposed surface (12) and the underlying structure (28). This gap may be simply be an air gap and may even provide for the ventilation of air between the roofing product and the underlying roof structure. Ventilation pathways may be incorporated such as those shown in FIG. 9. Ventilation paths (30) and (31) may also serve to enhance roof drainage of a roof of this type. FIG. 10 illustrates a contemplated embodiment of a spacer according to this invention with utility mounting hardware (32). These types of mounting hardware are typically required for mounting solar arrays and other roof-mounted equipment. FIG. 11 illustrates a contemplated embodiment of a spacer according to this invention with a headlap (33) for ease of installation and improved weather tightness of the assembled roof. FIG. 11 also illustrates a contemplated embodiment of a spacer according to this invention with at least one utility routing pathway (34). This can be utilized to move, store, and or manipulate the character of energy, gasses, liquids, and or electricity throughout the roof system. As but a few examples of the functional benefit of utility routing pathways is the integration of ice dam mitigation heaters, solar photovoltaic array interconnects, and hot liquid tubes such as for a solar thermal water heating systems. FIG. 12 illustrates a contemplated embodiment of a spacer according to this invention with decorative lights (35) such as holiday lights. This is a convenient method of installing light strings such as LED lights and keeps them substantially out of view when not in use. The lights might be positioned to wash light over a portion of the roof or direct light out beyond the roof.

I claim:

1. A roofing material having an inner bottom layer and an exposed outer layer having at least of a first set of surfaces generally oriented in an observer direction and at least a second set of surfaces generally oriented in a sun direction, wherein the surfaces are imparted to the roofing material by suitably profiled tooling affecting said outer layer and are treated to advantageously affect at least one of; reflective performance in the sun direction and aesthetic performance in the observer direction, when assembled onto a roof.

2. The roofing material of claim 1 comprising an asphalt shingle wherein the outer layer is a weathering material and granules.

3. The roofing material in claim 1 whereby said surfaces are imparted in any combination of repeating, non-repeating, apparently random, continuous, and non-continuous profiles.

4. The roofing material in claim 1 whereby said roofing material is treated before being shaped into said sets of surfaces.

5. The roofing material in claim 1 whereby said roofing material is profiled and treated after assembly onto a roof

6. A method of making a roofing material having a bottom layer and an exposed outer layer, comprising;
imparting to the outer layer at least one first surface generally oriented in an observer direction and at least one second surface generally oriented in a sun direction with suitably profiled tooling affecting said outer layer; and, treating the sun-facing surfaces to advantageously affect reflective performance and the observer-facing surface to advantageously affect aesthetic performance.

7. The method of claim 6 wherein the roofing material comprises an asphalt shingle and the outer layer is a weathering layer and granules.

8. The method of claim 6 wherein the surfaces are imparted in any combination of repeating, non-repeating, apparently random, continuous, and non-continuous profiles.

9. The method of claim 6 wherein the roofing material is treated before being shaped into said sets of surfaces.

10. The method of claim 6 wherein the roofing material is profiled and treated after assembly onto a roof.
